(19) United States
(12) Patent Application Publication
(10) Pub. No.: US 2007/0203596 A1
(43) Pub. Date: Aug. 30, 2007

(54) FM TRANSMISSION

(75) Inventors: Baoqian Huang, Shanghai (CN); Weijun Xu, Shanghai (CN)

Correspondence Address: KE LE, 20 LONG DR., WESTBOROUGH, MA, 01581, US

(73) Assignee: Accel Semiconductor Corporation

(21) Appl. No.: 11/463,019

(22) Filed: Aug. 8, 2006

Related U.S. Application Data
(60) Provisional application No. 60/777,057, filed on Feb. 28, 2006.

(51) Int. Cl. G06F 17/00; H04H 5/00

(52) U.S. Cl. 700/94; 381/3; 381/2

(57) ABSTRACT

An integrated circuit chip is described. The integrated circuit chip includes an audio input section for accepting audio signal, a digital signal processing section for processing the audio signal to perform audio encoding and frequency modulating, a frequency modulation signal processing section for up converting and transmitting the digital signal processor processed signal as a radio frequency signal and a frequency synthesizer for providing desired frequencies.

### CROSS REFERENCE TO RELATED APPLICATIONS

This application claims priority under 35 U.S.C. § 119(e) to provisional patent application No. 60/777,057, filed Feb. 28, 2006, the disclosure of which is hereby incorporated by reference herein.

### STATEMENT REGARDING FEDERALLY SPONSORED RESEARCH

Not Applicable.

### FIELD OF THE INVENTION

This description relates to frequency modulation (FM) signal transmission.

### SUMMARY

In general, in one aspect, the invention features an integrated circuit chip comprising an audio input section for accepting and processing the audio signal, a digital signal processing section for processing the audio signal to perform audio encoding and frequency modulating, a frequency modulation signal processing section for up converting and transmitting the digital signal processor processed signal as a radio frequency signal, and a frequency synthesizer for providing desired frequencies to the audio input section, the digital signal processing section, and the frequency modulation signal processing section.

Implementation of the invention may include one or more of the following features. The integrated circuit chip further comprises a single oscillator for generating a reference frequency. The audio signal in the integrated circuit chip is a stereo signal including a right channel and a left channel. The audio signal in the integrated circuit chip is a mono signal. The audio signal in the integrated circuit chip is a multi-channel surround signal. The audio signal in the integrated circuit chip is analog signal and the audio input processor includes low pass filter and analog-to-digital converter. The audio signal in the integrated circuit chip is digital signal. The frequency modulating in the integrated circuit chip is performed based on direct digital synthesizing.

In general, in another aspect, the invention features a method for processing an audio signal comprises processing the audio signal to perform audio encoding and frequency modulation in digital domain to generate digital processed audio signal, and up converting and transmitting the digital processed audio signal as a radio frequency signal.

Implementations of the invention may include one or more of the following features. The audio signal in the method is an analog audio signal. The method further comprises converting the analog audio signal into digital format before conduct the processing, and processing the audio signal to perform audio encoding and frequency modulation in digital format is performed in a single digital signal processor (DSP).

### BRIEF DESCRIPTION OF THE DRAWINGS

This invention is described with particularity in the detailed description. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates an IC chip block diagram.

FIG. 2 illustrates details of the digital signal processing section in FIG. 1.

FIG. 3 illustrates further details of frequency modulating in FIG. 2.

### DETAILED DESCRIPTION

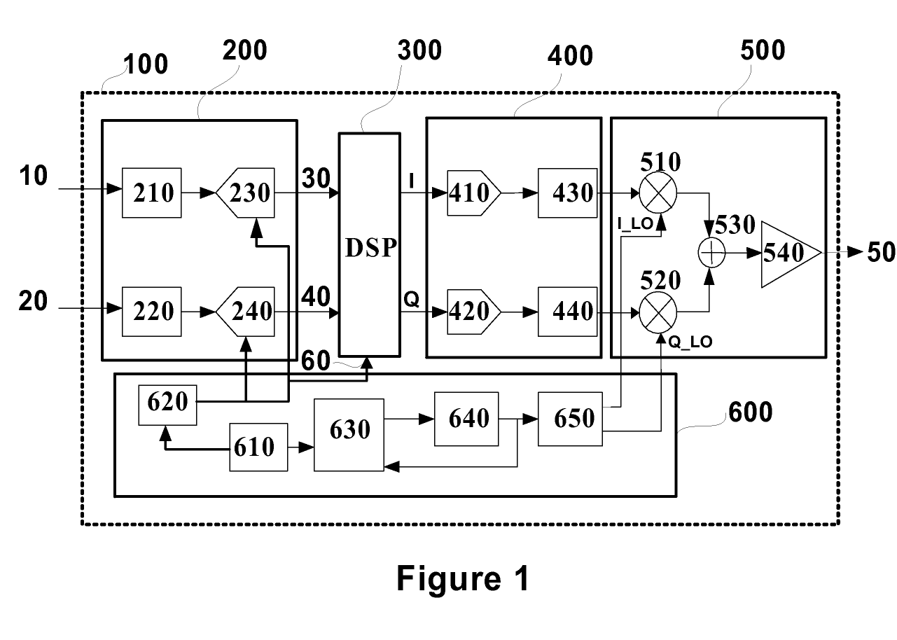

As shown in FIG. 1, an example integrated circuit (IC) chip 100 for audio signal processing and broadcasting accepts an audio signal as input. The example audio signal includes a right channel 10 and a left channel 20. The IC chip 100 outputs a RF signal 50 for broadcasting. The IC chip 100 comprises an audio input processing section 200 for performing various audio signal processing functions, a digital signal processing (DSP) section 300 for performing audio encoding and frequency modulation in digital domain, a signal output processing section 400, a FM signal processing section 500 for up converting processed signal and transmitting it as a RF signal and a frequency synthesizer 600 for providing desired frequencies to the audio input processing section 100, the digital signal processing section 300 and the FM signal processing section 500.

In one example, the audio signal is an analog stereo signal with a right stereo channel 10 and a left stereo channel 20 from an audio source such as a tape or cassette player, live, direct from the mixer, or live, via a link from studio, to name a few. In operation, the audio signal processing section 100 performs such example audio signal processing functions as low-pass filtering right stereo channel 10 and left stereo channel 20 via low pass filter 210 and 220 respectively. The low-pass processed right and left stereo channel analog signals are converted into digital signals via analog-to-digital converter (ADC) 230 and 240. The digitized right and left stereo signals 30 and 40 are fed into the DSP section 300 for further processing. It should be noted that audio signal processing section 200 may include other functionalities such as limiting and/or compressing, gain control and/or pre-emphasizing.

As will be described in more details below, the DSP section 300 performs audio encoding, in the example, stereo encoding in digital domain on digitized right and left stereo signals 30 and 40 to form a composite signal. The DSP further performs frequency modulating on the composite signal to generate digital in-phase signal (I) and digital quadrature-phase signal (Q) as outputs.

In the signal output processing section 400, the digital I and Q signal are converted into analog signals via digital-to-analog (DCA) converters 410 and 420 and processed, such as low-pass filtered by low-pass filters 430 and 440 respectively, before being sent to the FM signal processing section 500 for broadcasting.

The FM signal processing section 500 up converts the processed analog signals, amplifies the signal to be transmitted to increase the power output and broadcast it as a RF signal 50.

The integrated circuit (IC) chip 100 includes a frequency synthesizer 600 which comprises a single oscillator 610 such as a quartz oscillator for generating a reference frequency which may be used to derive various desired frequencies for all sections in the IC chip 100. In the example, a phase-loop-lock (PLL) 620 is used to generate desired frequencies for ADC in the audio signal processing section 100 and for stereo encoding in DSP section 300. Another phase-loop-lock (PLL) 630, along with a voltage-controlled-oscillator (VCO) 640 and a frequency divider 650, is used to generate desired frequencies for up-conversion in the FM signal processing section 500.

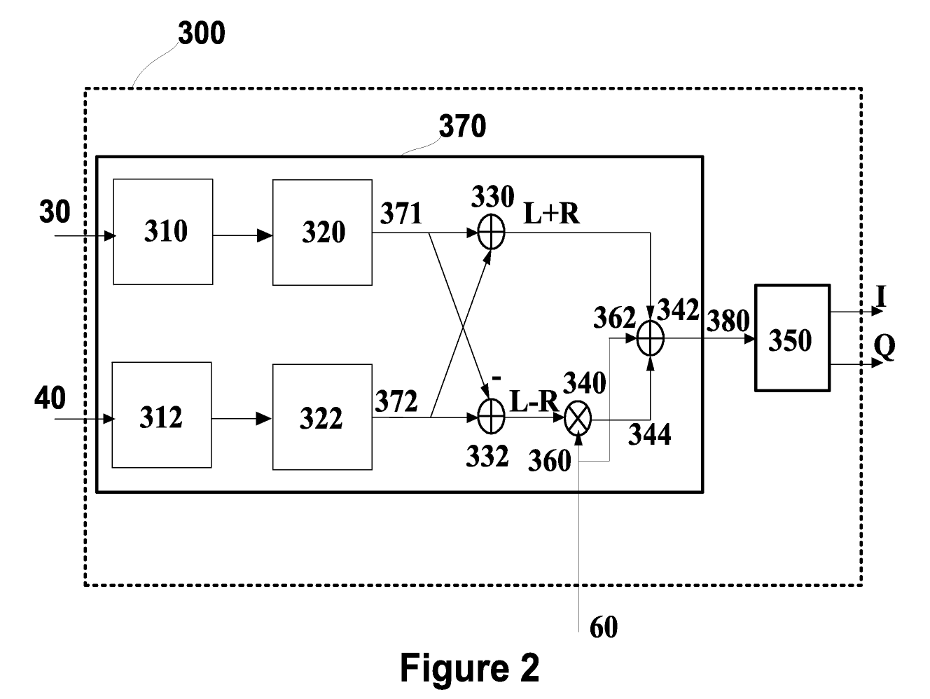

FIG. 2 shows additional details of DSP section 300. DSP section 300 further includes a digital audio encoding section 370 and a digital frequency modulating section 350. In the example, the digital audio encoding section 370 takes digital right and left stereo signals 30 and 40 as inputs, performs various processing on the input signals 30 and 40. In the example, the input signals are first passed through decimation filters 310 and 312 respectively to filter quantization noise from ADC 230 and 240 in FIG. 1 and to reduce frequency. The filtered signals can be further pre-emphasized by filters 320 and 322 to sufficiently boost the high frequencies to thereby represent a modulation frequency more accurately. The processed digital signals 371 and 372 are then audio encoded. In the example stereo encoder, L+R and L−R signals are first generated at 330 and 340 respectively. L−R signal is then mixed, at mixer 340, with a 38 KHz sub-carrier 360 to produce an amplitude modulated double sideband suppressed carrier signal 344. The 38 KHz signal can be generated from the single on-chip oscillator 610 by frequency division. A composite signal 380 outputted from the audio encoder 370 is formed by mixing, at mixer 342, the L+R signal, the double sideband suppressed carrier signal 344 and a bit of a 19 KHz pilot tone 362 which can also be generated from the same single on-chip oscillator 610 by frequency division.

FIG. 2 shows additional details of the digital frequency modulating section 350 in the DSP section 300. The digital frequency modulating section 350 takes the composite signal 380 as input and generates frequency modulated digital output signals I and Q via direct digital synthesizer (DSS) technique. The digital frequency modulating section 350 includes an amplitude-to-phase converter 351, a phase accumulator 352, a phase to amplitude converter 354, a ROM (read only memories) 358 for looking up sine-amplitude data and a phase shifter 356.

In operation, amplitude-to-phase converter 351 converts the composite signal 380 amplitude into a phase step value. The phase step value is fed into the clock signal controlled phase accumulator 352. The clock signal comes from the same single on-chip oscillator 610. The phase accumulator 352 has an adder 353 which adds, in synchronism with the clock signal 60, a constant “a” to phase step value. Namely, the adder 353 integrates, or accumulates, the constants “a” in accordance with the elapse of time, thereby outputting the phase data 355. When the cumulative value of the phase data 355 overflows, i.e., increases above the counting limit of the adder 353, the adder 353 omits a carry bit due to the overflow and then repeats the phase data accumulation. Therefore, the phase data 355 has a periodic saw-tooth waveform and corresponds to a sine signal.

By changing the phase step value as determined by the composite signal 380 amplitude, the periodicity or synthesized frequency of the accumulator output can be changed, an increase in the phase step value resulting in more frequent overflows of the accumulator, or a higher (synthesized) frequency, while a phase step value decrease results in a correspondingly lower output frequency, thus generating a frequency modulated signal. If the maximum capacity of the accumulator corresponds to 2π, and the phase step value Δφ is represented as 0˜2π phase angle, and the clock accumulating frequency is f_{—}_{^{accu}}, the accumulator output frequency f_{—}_{^{out}} will be:

$${f}_{\_out} = \frac{Δ φ}{2 π} {f}_{\_accu}$$

Assuming output signals I and Q have frequencies in the range of (f₁, f₂), the phase step values will be in the range of (2πf₁/f_{—}_{^{accu}},2πf₂/f_{—}_{^{accu}}). In one example, the composite signal 380 magnitude, assuming in the range of, (−M, M) can then be mapped, on-to-one, into phase step values.

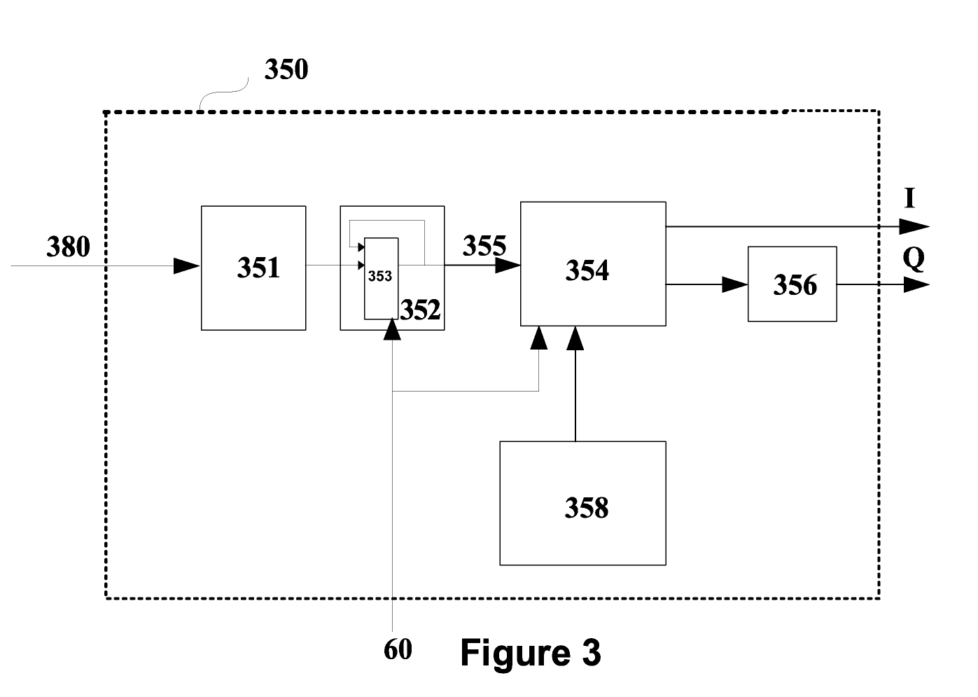

Referring back to FIG. 3, the phase to amplitude converter 354, takes phase output data 355 as input, converts it into amplitude values. In implementation, the upper bits of the phase output date 355 functions as an address to a look-up table stored in ROM 358 for sine amplitude values to generate a sine amplitude signal output I, and a cosine amplitude signal output Q via a 90 degree phase shifter 356.

The frequency modulated digital in-phase signal (I) and digital quadrature-phase signal (Q) outputted from digital signal processing section 300 are then fed into the signal output processing section 400, the digital I and Q signal are converted there into analog signals via digital-to-analog (DCA) converters 410 and 420 and processed such as low-pass filtered by low-pass filters 430 and 440 respectively before being sent to the FM signal processing section 500 for broadcasting.

The FM signal processing section 500 up converts the processed analog signals I and Q to higher RF frequency for transmission. Referring back to FM signal processing section 500 in FIG. 1, a mixer 510 is employed for up converting the analog I signal having frequency f_{I} to higher frequency signals by multiplying I signal with I_LO signal having frequency f_{I}_{_{—}}_{LO} from frequency synthesizer 600. The upper sideband frequency f_{I}+f_{I}_{_{—}}_{LO} and the lower sideband frequency f_{I}−f_{I}_{_{—}}_{LO} are generated as a result of the mixing process. One of the sideband frequencies is desired frequency f_{RF} to be transmitted while the other one is unwanted image frequency needs to be suppressed. In a similar fashion, another mixer 520 is employed to up convert analog Q signal to higher frequency signals. A mixer 530 is employed to suppress unwanted image frequency. The result is then fed into the RF amplified 540 to increase its power output and be broadcasted as a RF signal 50.

The example is described with an analog stereo audio signal having a left and right stereo channels, other implementations with different analog audio signal having different number of channels are also possible. In another example, a mono audio signal with a single channel can be fed into the described IC chip for RF signal transmission. In further another example, a multi-channel signals such as a 5.1 or 7.1 surround signal can be fed into the described IC chip for RF signal transmission. In each scenario, the audio encoding in digital signal processing section 300 will employ different audio encoders depending on the audio input signal. For example, for 5.1 surround audio input signal, a Dolby audio encoder can be employed.

The audio signal is not limited to analog signals; digital audio input signal can also be used with the described IC chip. In one example, when audio input signal is digital, the functions of the input processing section 200 will be adjuted accordingly. For example, ADC 210 and 220 will be bypassed.

Among advantages of the description, less off-chip components are needed since audio encoding and frequency modulation are performed in digital domain. In described IC chip, VCO (voltage controlled oscillator) and PLL only provide LO (low) frequencies. The general VCO requirements such as liner operation range and high frequencies outputs are greatly relaxed. Furthermore requirement on PLL bandwidth can also be relaxed from such as 20 Hz to a few KHz. Therefore, cost and component size can be reduced and performance can be improved. A total on chip design as described is therefore enabled. The frequency modulation resolution and bandwidth can be accurately controlled in digital signal processing to minimize adverse impact from temperature fluctuation in analog design.

While the description has been particularly shown and described with reference to specific exemplary embodiments, it is evident that those skilled in the art may now make numerous modifications of, departures from and uses of the specific apparatus and techniques herein disclosed. Consequently, other implementations are also within the scope of the following claims.

1. An integrated circuit (IC) chip, comprising:
an audio input section for accepting audio signal;
a digital signal processing section for processing the audio signal to perform audio encoding and frequency modulating;
a frequency modulation signal processing section for up converting and transmitting the digital signal processing section processed signal as a radio frequency signal;
a frequency synthesizer for providing desired frequencies to the audio input section, the digital signal processing section and the frequency modulation signal section.

2. The integrated circuit chip of claim 1 wherein the frequency synthesizer comprises a single oscillator for generating a reference frequency from which the desired frequencies can be derived.

3. The integrated circuit chip of claim 1 wherein the audio signal is a stereo signal including a right channel and a left channel.

4. The integrated circuit chip of claim 1 wherein the audio signal is a mono signal.

5. The integrated circuit chip of claim 1 wherein the audio signal is a multi-channel signal.

6. The integrated circuit chip of claim 5 wherein the multi-channel signal is a 5.1 discrete surround signal.

7. The integrated circuit chip of claim 1 wherein the audio signal is analog signal and the audio input processing section includes a low pass filter and an analog-to-digital converter.

8. The integrated circuit chip of claim 1 wherein the audio signal is digital signal.

9. The integrated circuit chip of claim 1 wherein the frequency modulating is performed based on direct digital synthesizing.

10. A method for processing an audio signal comprising:
processing the audio signal to perform audio encoding and frequency modulation in digital format to generate processed digital audio signal;
up converting and transmitting the processed digital audio signal as a radio frequency signal.

11. The method of claim 8 wherein the audio signal is an analog audio signal, the method further comprising converting the analog audio signal into digital format before conduct the processing.

12. The method of claim 8 wherein processing the audio signal to perform audio encoding and frequency modulation in digital format is performed in a single digital signal processor (DSP).
